(19) United States
(12) Patent Application Publication
(10) Pub. No.: US 2003/0162114 A1
(43) Pub. Date: Aug. 28, 2003

(54) Toner composition

(76) Inventors: Hendrik Jan Bolink, Maastricht (NL); Dirk Muscat, Gangelt-Brigden (DE); Dirk Armand Wim Stanssens, Houthalen (BE)

Correspondence Address: PILLSBURY WINTHROP, LLP, P.O. BOX 10500, MCLEAN, VA, 22102, US

(21) Appl. No.: 10/258,392

(22) PCT Filed: Apr. 20, 2001
(86) PCT No.: PCT/NL01/00318

(30) Foreign Application Priority Data
Apr. 25, 2000 (EP) 00201455.3

(51) Int. Cl. G03G 9/097

(52) U.S. Cl. 430/108.21

(57) ABSTRACT

The invention relates to a toner composition comprising a compound represented by formula (I):

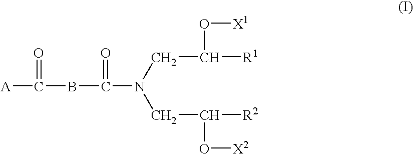

The toner composition shows improved high temperature off set resistance and charging properties.

The present invention relates to a toner composition.

As disclosed in “Electrography and development physics by L. B. Schein (Volume 14, pages 26-49) electrography is a complex process involving in most embodiments distinct steps being charging, exposing, developing, transferring, fusing and cleaning. During the development step the toner particles are brought into the vicinity of the latent image. By virtue of the electric field the toner adheres to the latent image, transforming it into a real image. Next the developed toner is transferred to the paper. The image is fixed to the paper by melting the toner into the paper surface. A toner composition may comprise a resin, a colorant, a charge control agent, magnetic material, carrier material and additives.

Often toners suffer mechanical friction when they receive shearing and impact forces caused by the mechanical operation of the apparatus, and the tones deteriote when several thousand to several ten thousand copies are produced. Such a toner deterioration may be avoided by the use of tough resin which has a molecular weight being high enough to be able to withstand the mechanical friction. However, resins of this kind generally have high softening points, so that fixing using infrared radiation cannot be sufficiently conducted because of poor thermal efficiency. Further, in the case of heated roller fixing which is a contact fixing technique extensively used because of its good thermal efficiency, there is the drawback that the temperature of the heated roller must be increased in order to attain sufficient fixing and the thus elevated roller temperature leads to a deterioration of the fixing apparatus, a curling of paper and an increase in the energy in the energy consumption. In addition, if such resins are used for producing toners, production efficiency is considerably lowered since the pulverizability of such resins is poor. Because of these drawbacks binder resins whose polymerisation degrees and softening points are too high cannot be used.

The heated roller fixing method involves exceedingly good thermal efficiency because a heated roller is brought into contact with a receiving sheet so that the toner image on the receiving sheet is pressed by the heated roller surface. Although this fixing method is widely used at fixing speeds ranging from low to high due to its good thermal efficiency an offset phenomenon is apt to occur where part of the toner adheres to the heated roller surface during contact of the heated roller with the toner image and is then transferred to a receiving paper or other receiving sheet. In order to avoid this phenomenon, rollers having surface layers made of a material with excellent release properties, such as a fluoroplastic, are employed and, in addition, a release agent such as for example a silicone oil is coated on the roller surface. A release agent has the disadvantage since this causes the apparatus to have an increased enlarged size, become more costly and also the resulting complicated structure is prone to be a cause of problems.

In general, the lowest fixing temperature for a toner is between the cold offset-disappearing temperature and the hot offset-occuring temperature and, hence, the usable temperature range is from the lowest fixing temperature to the hot offset-occurring temperature. Therefore, by lowering the lowest fixing temperature as much as possible and by increasing the hot offset-occuring temperature as much as possible. The usable fixing temperatures can be lowered and the usable temperature range can be increased at the same time, thereby attaining energy saving, high speed fixing and prevention of paper curling.

It is the object of the present invention to provide a toner composition which shows simultaneously low-temperature flexibility, anti-blocking properties, excellent charging and high temperature offset resistance because these characteristics are inherently supposed to be incompatible.

The toner composition according to the invention is characterised in that the toner composition comprises a compound represented by formula (I):

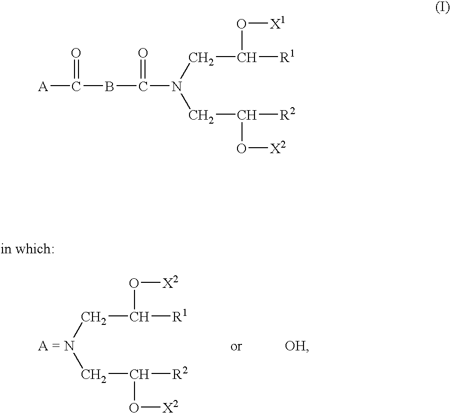

B=(C₂-C₁₂), optionally substituted, aryl or (cyclo) alkyl aliphatic diradical,

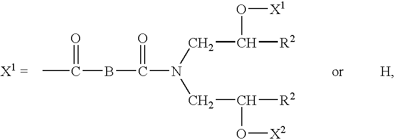

X²=H, X¹ or E—R³,

R¹ and R² may, independently of one another, be the same or different, H, (C₆-C₁₀) aryl or (C₁-C₈)(cyclo) alkyl radical, E is derived from a reactive group selected from carboxylic acid, carboxylic ester, carboxylic anhydride, epoxy, isocyanate, acid chloride, amine and/or methylolated amide and R³ may be selected from, for example, a saturated or unsaturated (C₁-C₁₀₀₀), preferably (C₁-C₄₀₀), alkyl or aromatic group, a polymer or an oligomer. Examples of suitable polymers include polyesters, polyethers, polyethylene, polypropylene and poly(capro)lactones.

The molecular weight Mn of the compound generally ranges between 500 and 250000 and preferably between 500 and 150000.

The toner composition according to the invention reaches a higher charging magnitude and shows an improved high temperature off set resistance.

Preferably,

E is

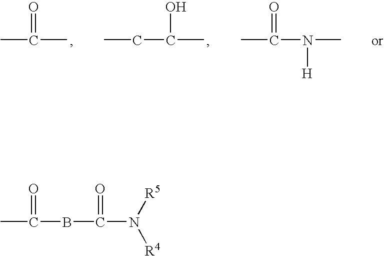

in which R⁴ and R⁵ may be R³ or R¹.

Preferably, R¹=H or (C₆-C₁₀) aryl or (C₁-C₈) (cyclo) alkyl radical.

Preferably R²=H or (C₆-C₁₀) aryl or (C₁-C₈) (cyclo) alkyl radical.

More preferably R¹and R² are (C₁-C₄) alkyl.

According to a further preferred embodiment of the invention R¹ and R² are methyl or ethyl.

R³, R⁴ and/or R⁵ are optionally heteroatom substituted (C₁-C₂₈) alkyl groups.

R³, R⁴ and/or R⁵ may be selected from the group consisting of optionally heteroatom substituted (C₆-C₁₀) arylgroups or optionally heteroatom substituted (C₁-C₂₈) alkylgroups.

According to a preferred embodiment of the invention R³, R⁴ and/or R⁵ are substituted (C₁-C₂₈) alkyl groups.

R³, R⁴ and/or R⁵ may be substituted with a group selected from the group of alcohol, ether, ester, cyanide, carbonate, urethane, urea, amide, imide, amine, imine, imidazole, oxime, sulfide, thiol, thiourea, sulfon, silane, silicone, silicate, fluoro, chloro, bromo or iodo groups. Suitable examples include di(m)ethylaminoethyl, di(m)ethylaminopropyl, di(m)ethylaminohexyl, tri(m)ethylsilylpropyl, tri(m)ethoxysilylpropyl, perfluoro-octyl, perfluoro-octyl-(m)ethyl, (m)ethoxy-ethyl, (m)ethoxy-2-propyl, maleimido-propyl, maleimido-hexyl, octenylsuccinimido-hexyl, hexahydrophthalimido-hexyl, 2-(benz)imidazole-ethyl, difenylfosfino-ethyl, furfuryl, cyanoethyl, or cyanopropyl groups. R³, R⁴ and/or R⁵ may also be part of the same optionally substituted cyclic group, such as for example a morfoline, thiomorfoline, piperidine, pyrrolidine, oxazolidine, thiazolidine or piperazine group.

The compound may consist of the same or different R³ groups.

More preferably E is

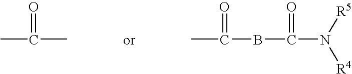

Most preferably E is derived from a carboxylic acid group.

Suitable carboxylic acids to be applied as basic components for E—R³ are, for example, saturated aliphatic (C₁-C₂₆) acids, unsaturated (C₁-C₂₀) fatty acids, aromatic acids and α,β-unsaturated acids.

Examples of suitable α,β-unsaturated acids are (meth)acrylic acid, crotonic acid and monoesters or monoamides of itaconic acid, maleic acid, 12-hydroxystearic acid, polyether carboxylic acid and fumaric acid.

Suitable saturated aliphatic acids are for example acetic acid, propionic acid, butyric acid,-2-ethyl hexanoic acid, laurylic acid and stearic acid. Suitable carboxylic acids are, for example, saturated aliphatic (C₁-C₂₆) acids, unsaturated (C₁-C₂₀) fatty acids, aromatic acids and α,β-unsaturated acids.

Examples of suitable α,β-unsaturated acids are (meth)acrylic acid, crotonic acid and monoesters or monoamides of itaconic acid, maleic acid, 12-hydroxystearic acid, polyether carboxylic acid, and fumaric acid.

Suitable saturated aliphatic acids are for example acetic acid, propionic acid, butyric acid, 2-ethyl hexanoic acid, laurylic acid and stearic acid. Suitable aromatic acid are for example benzoic acid and tertiairy butyl benzoic acid.

A preferred compound (Hybrane PS ₂₅₅₀™ of DSM) is represented by formula (II):

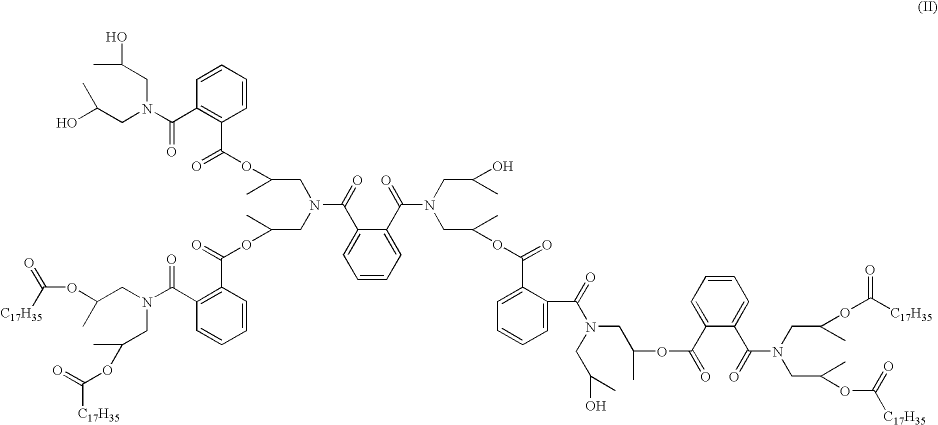

Another preferred compound (Hybrane PS ₂₆₃₀™ of DSM) is represented by formula (III):

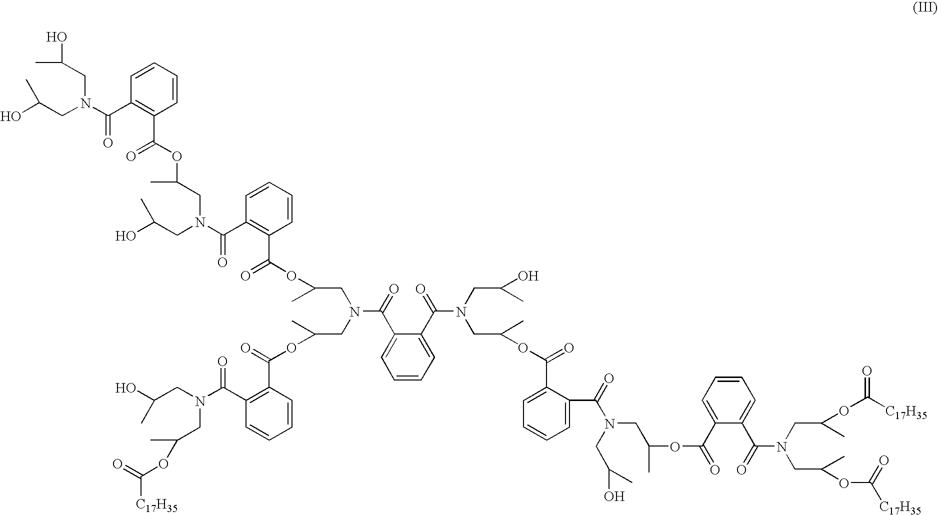

The compound used in the toner composition may be prepared for example by a process as disclosed in WO-A-9916810 which publication is directed to a condensation polymer containing ester groups and at least one amide group in the backbone and having at least one hydroxyalkylamide end group.

The compound may also be prepared by a process according to PCT/NL00/00197 (WO-A-00/56804) which is directed to a condensation polymer having at least one dialkylamide endgroup connected through the polymer backbone to a unit derived from an alkylamide, the connection comprising at least one ester linkage.

The toner composition may comprise the compound, a resin, a colorant, a charge control agent, magnetic material and/or additives.

The toner composition according to the invention prevents high temperature offset without applying an oil on the fixing roll.

The compound may be present in an amount between 0, 1 and 100% by weight (relative to the total amount of resin and compound) in the toner composition. The function of the compound may be compatabiliser, charge control agent, release agent(wax) and/or binder resin. The selected amount of the compound depends on the function of this compound.

Suitable resins include for example polyesters, polyamides, polyolefins, styrene (meth)acrylates, styrene butadienes, crosslinked styrene polymers, epoxies, polyurethanes, vinyl resins and/or polyester imides.

Preferably, the resin is a polyester and/or a styrene acrylate. According to a further preferred embodiment of the invention the polyester is a bisphenol free polyester.

The acid number of an acid functional polyester containing carboxylic acid is preferably higher than 10 mg KOH/ gr resin, and preferably higher than 15 mg KOH/ gr resin. The acid number is preferably lower than 60 mg KOH/gr resin and less than 35 mg KOH/ gr resin. The polyester may also be hydroxyl functional, epoxy functional or phosphoric acid functional. The Tg of the polyester may be greater than 45° C., and is preferably greater than 60° C. The Tg is generally lower than 90° C.

Additionally, also charge control agents, for example, a positive-charge control agent or a negative-charge control agent may be applied.

Examples of a suitable positive-charge control agent include nigrosine dyes, triphenylmethane dyes containing a tertiary amine as a pendant group, quaternary ammonium salt compounds, cetyltrimethylammonium bromide, polyamine resins, imidazole derivatives.

Examples of a suitable negative-charge control agent include metal-containing azo dyes, copper phthalocyanine dyes, metal complexes of salicylic alkyl derivatives and quaternary ammonium salts.

The charge control agent may be incorporated in the toner in an amount from, for example, 0.1 to 8.0% by weight. Preferably, this amount is between 0.2 and 5.0% by weight, based on the amount of the binder resin.

During the production of toners, modifiers are usually added or incorporated therein. Suitable modifiers include for example anti-offset agents such as for example polyolefin waxes and other waxes and flow modifiers for example hydrophobic silica. However, in the case of a toner composition comprising the compound according to the formula as the binder resin, there is no need of adding such a modifier, and even if a modifier is incorporated, its amount may be reduced. The amount of anti-offset agent and flow modifier may be between, for example, 0.5 to 10% by weight and 0.05 to 5.0% by weight, respectively.

A toner may, for example, be obtained by uniformely dispersing additives such as for instance, a colorant, a charge control agent, a magnetic material and/or a modifier into the polymer. The resulting mixture is melt kneaded, cooled, pulverized, and then classified to thereby obtain a toner having an average particle diameter between for example 5 and 15 μm. This toner may be mixed with a magnetic powder, i.e. an iron oxide carrier, a truly spherical iron oxide carrier, or a ferrite carrier, to give a dry two-component developer. In this case, the magnetic powder is used as it is or after being coated with a resin or other material.

In the case of producing a magnetic toner comprising for example the polyester resin the magnetic material used may be a powder of a ferromagnetic metal such as for example iron, cobalt nickel or an alloy or compound containing an element exhibiting ferromagnetism such as for example ferrite, hematite or magnetite. The magnetic material may be used in the form of a fine powder having an average particle diameter between 0.1 and 1 μm and the amount of the magnetic material dispersed into the binder resin may be between 30 and 70 parts by weight per 100 parts by weight of the binder resin.

The toner may also be obtained by a chemical route, a polymerised toner or an emulsion dispersion route.

According to a further embodiment of the invention the compound represented by formula (I):

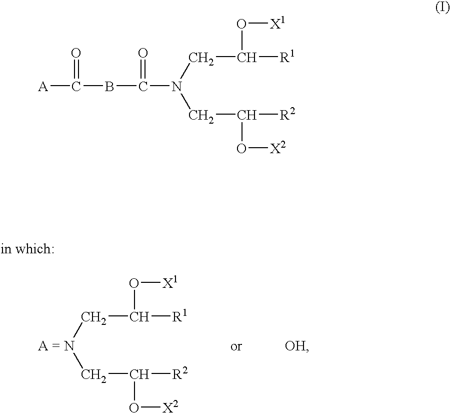

B=(C₂-C₁₂), optionally substituted, aryl or (cyclo) alkyl aliphatic diradical,

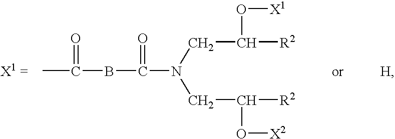

X² =H,X¹ or E—R³,

R¹ and R² may, independently of one another, be the same or different, H, (C₆-C₁₀) aryl or (C₁-C₈)(cyclo) alkyl radical, E is derived from a reactive group selected from carboxylic acid, carboxylic ester, carboxylic anhydride, epoxy, isocyanate, acid chloride, amine and/or methylolated amide and R³ may be selected from, for example, a saturated or unsaturated (C₁-C₁₀₀₀), preferably (C₁-C₄₀₀), alkyl or aromatic group, a polymer or an oligomer, or formulas (II) and (III) used as a wax. The wax may also be used in for example polymers, in packaging applications and protective coating applications.

The invention will be elucidated with reference to the following non-limiting examples.

### EXAMPLE I

A toner was prepared by adding to an extruder 4200 grams of polyester resin (Uralac P2610™ of DSM Resins), 200 grams pigment (Cyan pigment Heligon Blue of BASF), 100 grams charge control additive (Bontron E-84 of Orient) and 500 grams of the compound according to Formula II (Hybrane PS 2550™ of DSM).

The resulting extrudate was crushed and milled to an average particle size (mean) of 7 micrometer.

The Tg as measured with Differential Scanning Calorimetry (DSC), using a heating rate of 10 degrees per minute and determining the onset of Tg from the second heating curve, was 57° C.

The viscosity of the toner at 120° C. and 1 rad/second measured with dynamical mechanical spectroscopy was 450 Pa.s.

The charge to mass ratio of the toner was -55 microcoulomb per gram (as measured against a Ferrite carrier with an average particle size of 50 micrometer and coated with a siloxane resin using a Faraday cage charging device (q/m meter from Epping GmbH)).

### EXAMPLE II

A toner was prepared by adding to an extruder 3700 grams of polyester resin (Uralac P2610™ of DSM Resins), 200 grams pigment (Cyan pigment Heligon Blue of BASF), 100 grams charge control additive (Bontron E-84 of Orient) and 1000 grams of the compound according to Formula II (Hybrane PS 2550™ of DSM).

The resulting extrudate was crushed and milled to an average particle size (mean) of 7 micrometer.

Using the same analytical equipment and settings as for the toner described in Example I, the following characteristics were measured

Tg=55° C.,

viscosity=400 Pa.s and

the charge to mass=−77 microcoulomb.

### COMPARATIVE EXAMPLE A

A toner was prepared by adding to an extruder 4700 grams of polyester resin (Uralac P2610™ of DSM Resins), 200 grams (4 wt %) pigment (Cyan pigment Heligon Blue of BASF) and 100 grams (2 wt %) charge control additive (Bontron E-84 of Orient).

The resulting extrudate was crushed and milled to an average particle size (mean) of 7 micrometer.

Using the same analytical equipment and settings as for the toner described in Example I, the following characteristics were measured:

Tg=59° C.,

viscosity=500 Pa.s and

the charge to mass=−14 microcoulomb.

1. A toner composition comprising a compound represented by formula (I): 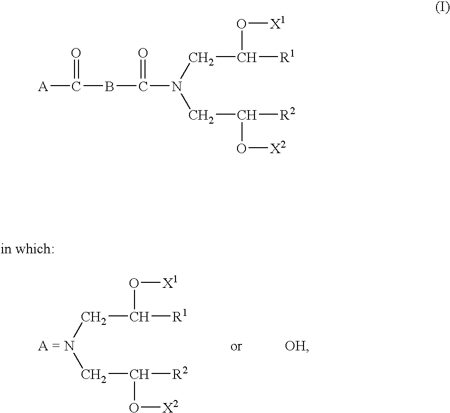
B=(C₂-C₁₂), optionally substituted, aryl or (cyclo)alkyl aliphatic diradical, 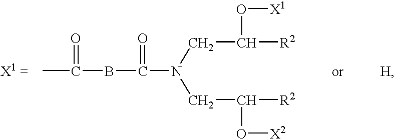
X²=H, X¹ or E—R³,
R¹ and R² may, independently of one another, be the same or different,
H, (C₆-C₁₀) aryl of (C₁-C₈) (cyclo)alkyl radical,
E is derived from a reactive group selected from carboxylic acid, carboxylic ester, carboxylic anhydride, epoxy, isocyanate, acid chloride, amine and/or methylolated amide and
R³ is selected from a saturated or unsaturated (C₁-C₁₀₀₀) alkyl or aromatic group, a polymer or an oligomer.

2. A composition according to claim 1 characterised in that E is 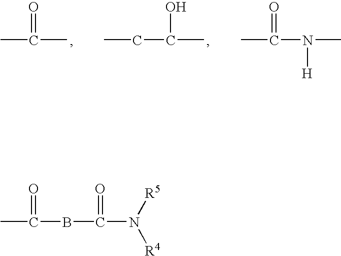
in which R⁴ and R⁵ may be R³ or R¹.

3. A composition according to any one of claims 1-2 characterised in that R¹=H or (C₆-C₁₀) aryl or (C₁-C₈)(cyclo)alkyl radical.

4. A composition according to any one of claims 1-3 characterised in that R²=H or (C₆-C₁₀) aryl or (C₁-C₈)(cyclo)alkyl radical.

5. A composition according to any one of claims 1-4, characterised in that the compound is a compound represented by formula (II): 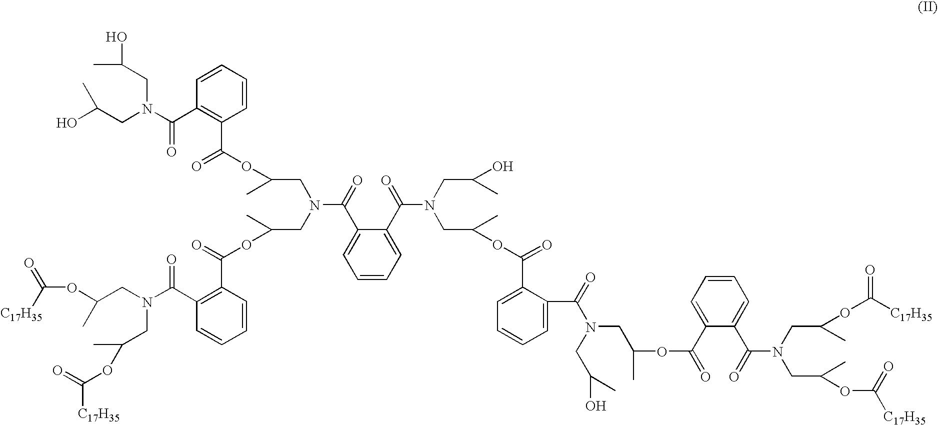
or is a compound represented by formula (III):

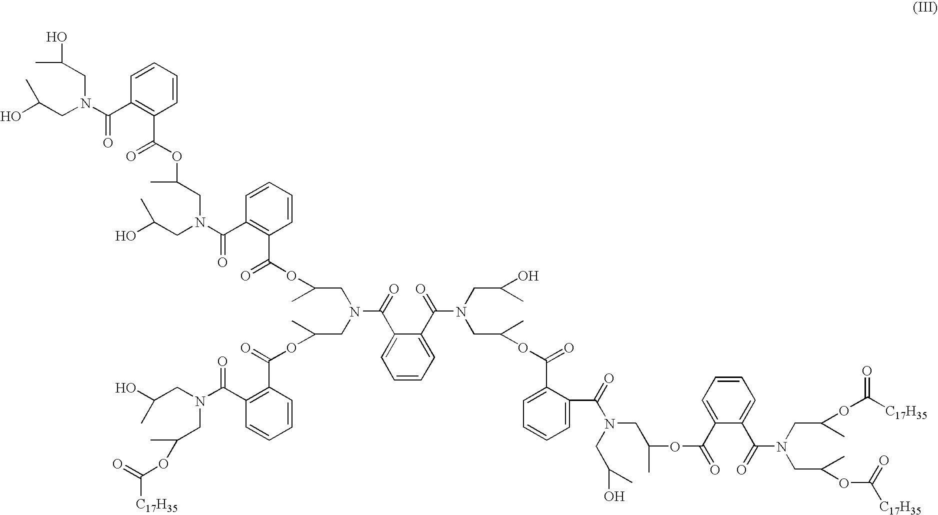

6. Use of a compound represented by formula (I): 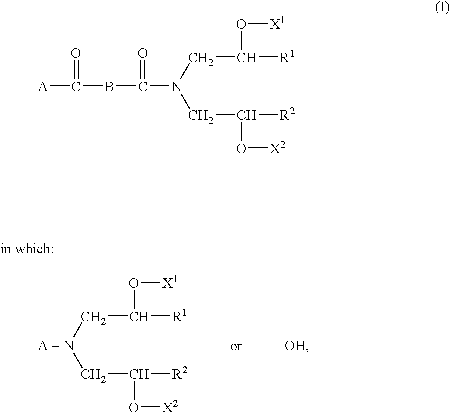
B=(C₂-C₁₂), optionally substituted, aryl or (cyclo) alkyl aliphatic diradical, 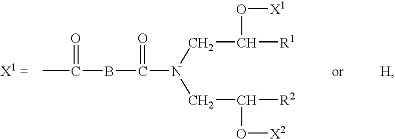
X²=H, X¹ or E—R³,
R¹ and R² may, independently of one another, be the same or different,
H, (C₆-C₁₀) aryl or (C₁-C₈)(cyclo) alkyl radical, E is derived from a reactive group selected from carboxylic acid, carboxylic ester, carboxylic anhydride, epoxy, isocyanate, acid chloride, amine and/or methylolated amide and R³ is selected from a saturated or unsaturated (C₁-C₁₀₀₀), alkyl or aromatic group, a polymer or an oligomer as a wax.
